(19) United States
(12) Patent Application Publication
(10) Pub. No.: US 2011/0196798 A1
(43) Pub. Date: Aug. 11, 2011

(54) Project Management Robot Method and System

(75) Inventor: Yegor Bugayenko, Sliema (MT)

(73) Assignee: Yegor Bugayenko, Sliema (MT)

(21) Appl. No.: 12/703,202

(22) Filed: Feb. 10, 2010

(51) Int. Cl. G06Q 10/00

(52) U.S. Cl. 705/301

(57) ABSTRACT

The invented method replaces a human being project manager with a robotic soft-ware (called Wobot), which performs the majority of project management processes, including planning, controlling, monitoring and closing of project activities. The role of the human being is narrowed down to only providing primary measurable project objectives.

### BACKGROUND

1. Field of Invention

The present invention generally relates to project management, specifically systems and methods used in the area of software development, but also widely popular in manufacturing, service providing, healthcare, construction, airspace and other industries.

2. Prior Art

Project management (which arose as a discipline from management in the 1950s) is supported and developed by international organizations like IPMA and PMI. A number of project management guidelines and standards have been published since then, like ICB [13], PMBOK [14], PRINCE2 [11], ISO-10006 [10] and BS-6079 [9], as well as a number of software development life-cycle frameworks like CMMI [12], RUP [2], IEEE-12207[3] and MSF [35]. When used properly, these project management standards are designed to guarantee the success of almost any project [31].

Despite the widespread common knowledge of project management practices, the “failure rate” of project management in the software industry is still very high [30, 24, 26]. Very often, the most critical causes of failure are project management mistakes [31, 28]. Some studies of the software development industry indicate that “software quality is not improving but getting worse” [8], and in most cases the root cause is defective project management.

In a mid-sized software development project, there are numerous routine and important tasks to be done by a project manager. Some studies show that the number of different types of tasks are over one hundred [23]. Obviously, people tend to cut corners, avoid repeatable and routine operations, and rely on intuition instead of formulas. Such a simplification of project management principles dictated by industry standards lead to failure.

Many modern software products automate project management disciplines such as time planning and tracking, resource management, issue tracking, cost control and quality control. These are available online or as standalone tools, e.g. basecam-phq.com, huddle.net, Microsoft Project, Oracle Primavera P3, Trac, JIRA and others. With different success rates, [32, 15] these instruments help project managers to automate their routine work related to time, cost, scope, quality and risk [16, 19, 21] management.

Despite the complexity and maturity of existing project management tools and instruments, still qualification [29], motivation and proficiency of the project manager in charge [33, 25, 27] remain high-impact factors of project success. So far, no replacement of the project manager by some automated tool (such as a robot) has been proposed.

### SUMMARY

The invented “Project management robot method and system” includes a specific software that acts on the behalf of a project manager in a project, implementing most project management tools and techniques [14] without the active participation of human beings. This automated project stakeholder is called the Wobot.

The Wobot automates the most time-consuming and routine tools and methods normally performed in a project by human beings, including: metrics collection, WBS development, activities definition and sequencing, network diagram, critical path method, risk quantitative and qualitative analysis, earned value analysis and “what-if” analysis. Most of these tools and methods are implemented by the Wobot with or without minimal interaction from a human being.

The output of the Wobot's activity is a series of work orders assigned to certain project performers. The work orders change in time according to the management decisions made by the Wobot.

In order to make said management decisions, the Wobot uses a limited and strictly formal set of metrics, which are collected automatically from project artifacts. The Wobot identifies the work to be done in the Work Breakdown Structure (WBS), using primary and secondary objectives. Primary objectives are provided by project stakeholders, and secondary objectives are derived from primary objectives by the Wobot.

The invented method and software that replace a human being project manager with the Wobot give a number of benefits to a project, such as: a) higher predictability, b) cost of labor cut, c) a more objective view of project performance, d) the ability to apply a full-scale project management within a limited project budget and e) higher stability of an entire project.

### SHORT DESCRIPTION OF DRAWINGS

FIG. 1 is a general workflow of actions, documents and decisions made by the Wobot and human beings in a project.

### DETAILED DESCRIPTION OF DRAWINGS

While this invention is susceptible to be embodied in many different forms, a specific embodiment is shown in the drawing and will be described herein in detail. The present disclosure is to be considered as an exemplification of the principles of the invention and is not intended to limit the invention to the specific embodiments illustrated.

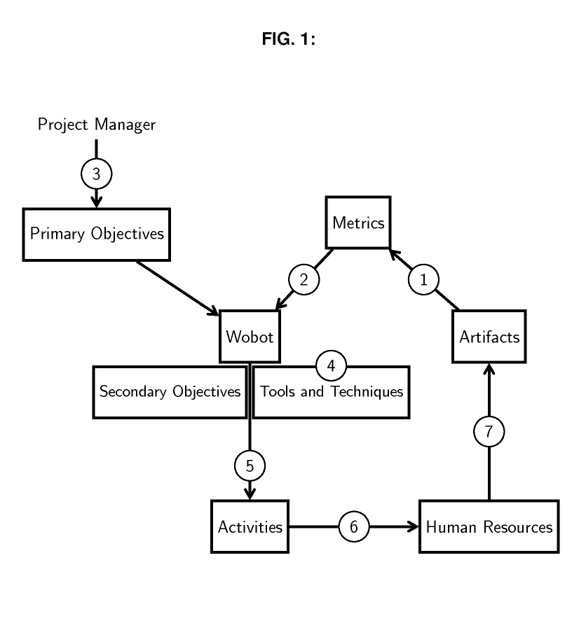

FIG. 1 explains the workflow of actions that the Wobot is performing when it is managing a project through key stages:
1. The Wobot is collecting measurable metrics, automatically deriving them from project artifacts, at (1) and (2).
2. The Wobot is receiving numeric objectives from designated stakeholders (mostly from a project manager), related to the metrics collected, at (3).
3. The Wobot is applying project management tools and techniques in order to make necessary management decisions, at (4).
4. The Wobot is producing secondary objectives according to the metrics collected and primary objectives received from project stakeholders, at (5).
5. The Wobot is assigning, monitoring and closing project activities (also known as work orders) at (6), and is in direct contact with human resources responsible for certain project artifacts, at (7).
6. It is re-iterating.

The Wobot is an automata, which pretends to be an actual project stakeholder and replaces a human being project manager. Most of the operations done by a typical project manager are routine and take a lot of valuable time, like network diagram, activity definition and sequencing, “what-if” analysis, risk quantitative and qualitative analysis, and more. Such operations could and should be automated by the Wobot using, when required, some input from human beings.

At (1), the metrics are defined and collected. Metrics are numeric characteristics of project artifacts. Most important artifacts in a software development project include: software requirements specification [5], software architecture [7] and design specifications [4], defects in defects tracking system [6] and source code with test elements. Metrics are collected automatically by designated collectors—special tools and instruments that regularly review the project artifacts, analyze them, collect numeric parameters and represent them in computer-friendly format, preferably in XML [20].

At (2), the metrics are delivered to the Wobot through the network or by means of local file deployment. XML format is used for better interoperability between the Wobot and metric collectors. The most important metrics in a software development project include, for example: traceability of artifacts, requirements volatility, correctness of requirements, source lines of code, cyclomatic complexity, function points, cohesion and coupling, test code coverage, code compliance to coding standards and many others [22, 17]. Most of the artifacts can be maintained with the automation enough to allow metrics collectors to gather information about their quality characteristics. The number of metrics even in a small software development project is rather big—hundreds or even thousands.

At (3), project stakeholders (mostly the project manager) provide their primary objectives in form of a collection of measurable metrics. Good examples of primary objectives are: milestones and other time constraints, budget limitations, availability of human resources and quality requirements. Primary objectives shall be expressed in the form of predicates on the set of available metrics. In other words, any primary objective shall require a project to reach certain values of certain metrics at a certain moment.

The primary objectives are control means between people and the Wobot. In order to affect the behavior of the Wobot, one needs to make changes in one or more of the primary objectives.

At (4), the Wobot combines together primary objectives and the metrics retrieved from collectors, and applies a number of techniques in order to generate secondary objectives. The set of secondary objectives is a project roadmap that explains what goals shall be achieved and when, to the very last detail. This is an example of secondary objectives in a software development project:

| ID | Metric | Value |
|---|---|---|
| T1 | Total defects found in SRS | 550 |
| T2 | Total defects fixed in code | 2500 |
| D1 | Classes designed, total | 100 |
| D2 | Methods designed, total | 800 |

Secondary objectives are not tied to a timeline and do not say explicitly when the results shall be achieved. A full set of secondary objectives is a global target of the entire project, which when achieved signals that the project is completed and ready for closure.

At (5), the Wobot converts the roadmap of secondary objectives to the sequence of activities, which should be implemented by project stakeholders (i.e. programmers, designers, architects, testers, deployment engineers and configuration engineers).

Every activity (also known as task, work order or issue) has a project stakeholder as a performer, and “acceptance criteria” in the form of a) a boolean predicate, or b) a project stakeholder as a validator, or c) a combination of both. The Wobot records, maintain and archive activities in a ticket management system, like Bugzilla [1], Trac [34], Jira [18] or similar.

Boolean predicate is a much more preferred form of activity acceptance criteria definition. When the acceptance criteria of an activity is difficult to measure on a numeric or logical scale, a human being validator is a possible solution.

Some examples of activity definitions and acceptance criteria:
Definition: To implement class XmlGateway.java and enable functionality specified by R5.6 and R5.7.6
Performer: James Wilson (programmer)
Validator: John Doe (designer or architect)
   p₁( ) code coverage of XmlGateway.java is over 80%
   p₂( ) peak cyclomatic complexity is less than 5
   P₃( ) R5.6 and R5.7.6 are accepted by end-users

In the example above the activity requires a programmer to implement specified Java class (XmlGateway.java) and make sure that because of this implementation functional requirements R5.6 and R5.7.6 become workable, testable and accepted by end-users. Such an activity definition is very common for software development projects and can be created by the Wobot, using the following information: a) a full list of functional requirements and their priorities, complexities and statuses; b) traceability links between design elements and requirements; c) role assignment information, including requirements and design responsibility links.

The Wobot considers the activity completed only if the validator says so by changing the status in the ticket management system, and all predicates p₁( ), p₂( ), and p₃( ) are true. The Wobot checks the validity of predicates through project metrics collectors. User acceptance of R5.6 and R5.7.6 is also a metric, collected on a ticket database.

Thus, every activity created by the Wobot is an interface between two project stakeholders (performer and validator) and project artifacts. In this aggregation the Wobot plays the role of a dispatcher, having no knowledge about the nature of activity or accomplished changes on the artifacts. Ideally, every human being project manager shall act similar in his/her projects and only manage technical specialists without any specific knowledge in the technical domain.

At (6), the Wobot assigns the activities to their performers and validators. The Wobot doesn't control the results of activities, but only validates the changes in project metrics if they are happening due to the changes made by performers to the project artifacts, at (7). Thus, the interaction between the Wobot and project performers is one-way only.

When re-iterating the explained scenario the Wobot is starting from scratch, collecting metrics and primary objectives (obviously database caching technologies are used in order to avoid multiple requests for the same information). The Wobot then creates a new set of secondary objectives and a new list of activities. Some of the activities in the new list will be identical to the activities already assigned to performers and won't be changed. Others will be different from what was previously assigned. In such a case, obsolete activities will be stopped and closed, and new activities will be created and assigned to performers.

The Wobot always plans the project from a current situation and moment in time. Historical records are used always as information from the past, which is valuable but still historical. Every time the Wobot analyzes project metrics and objectives, this analysis assumes that now is the first minute of the project. Such an assumption leads to always-current plans, forecasts and resource allocation decisions. U.S. Patent Documents

| | | |
|---|---|---|
| 5,848,394 | December 1998 | D'Arrigo et al. |
| 6,397,202 | May 2002 | Higgins et al. |
| 6,519,763 | February 2003 | Kaufer et al. |
| 7,159,206 | January 2007 | Sadhu et al. |
| 7,562,338 | July 2009 | Knutson et al. |
| 7,603,653 | October 2009 | Sundararajan et al. |
| 09/904,644 | January 2003 | Roetzheim |
| 10/975,918 | May 2006 | Oikawa |
| 11/106,765 | October 2006 | Guckenheimer |
| 12/022,444 | July 2009 | Mitchel |
| 12/491,491 | June 2009 | Knutson et al. |

### REFERENCES

[1] Bugzilla is server software designed to help to manage software development.
[2] Rational unified process (rup). Technical Report 7.0, International Business Machines (IBM).
[3] Standard for information technology-software life cycle processes. Technical Report IEEE 12207, The Institute of Electrical and Electronics Engineers.
[4] Recommended practice for software design descriptions. Technical Report Std 1016-1987, The Institute of Electrical and Electronics Engineers (IEEE), 1998.
[5] Recommended practice for software requirements specifications. Technical Report IEEE Std 830-1998, The Institute of Electrical and Electronics Engineers, 1998.
[6] Standard for software test documentation. Technical report, The Institute of Electrical and Electronics Engineers, 1998.
[7] Recommended practice for architectural description of software-intensive systems. Technical Report IEEE Std 1471-2000, The Institute of Electrical and Electronics Engineers, 2000.
[8] Extreme chaos. Technical report, The Standish Group International, 2001.
[9] Project management. guide to project management. Technical Report BS 6079-1:2002, The British Standards Institution, May 2002.
[10] Quality management systems—guidelines for quality management in projects. Technical Report ISO 10006:2003, ISO, 2003.
[11] Managing Successful Projects with PRINCE2. Office of Government Commerce (OGC), London, UK, 2005.
[12] CMMI for Development, Version 1.2. Number CMU/SEI-2006-TR-008. Software Engineering Institute, August 2006.
[13] IPMA Competence Baseline Version 3.0. International Project Management Association, The Netherlands, June 2006.
[14] Project Management Body of Knowledge, Guide 4th Edition. Project Management Institute, 2008.
[15] Abdullah, Frank T. Anbari, and William H. Money. Impact of organizational and project factors on acceptance and usage of project management software and perceived project success. Project Management Journal, 39(2):5-33, 2008.
[16] Tom Addison and Seema Vallabh. Controlling software project risks: an empirical study of methods used by experienced project managers. In SAICSIT '02: Proceedings of the 2002 annual research conference of the South African institute of computer scientists and information technologists on Enablement through technology, pages 128-140, Republic of South Africa, 2002. South African Institute for Computer Scientists and Information Technologists.
[17] Wasif Afzal and Richard Torkar. Incorporating metrics in an organizational test strategy. In ICSTW '08: Proceedings of the 2008 IEEE International Conference on Software Testing Verification and Validation Workshop, pages 304-315, Washington, D.C., USA, 2008. IEEE Computer Society.
[18] Altassian. Jira project management toolkit.
[19] Barry W. Boehm. Software risk management: Principles and practices. IEEE Software, 8(1):32-41, 1991.
[20] Tim Bray, Jean Paoli, C. M. Sperberg-McQueen, Eve Maler, and François Yergeau. Extensible markup language (xml) 1.0 (fifth edition), November 2008.
[21] Yegor Bugayenko. Competitive risk identification method for distributed teams. In Third International Conference on Software Engineering Approaches for Offshore and Outsourced Development (SEAFOOD), Switzerland, Zurich, June 2009.
[22] Yegor Bugayenko. Quality of code can be planned and controlled. In International Conference on Software Validation and Verification (VALID), Portugal, Porto, September 2009.
[23] Yegor Bugayenko. Quality of process control in software projects. In IWSM/Mensura 2009 International Conference on Software Measurement, Software Process and Product Measurement, Amsterdam, Netherlands, November 2009.
[24] Narciso Cerpa and June M. Verner. Why did your project fail? Commun. ACM, 52(12):130-134, 2009.
[25] Terry Cooke-Davies. The “real” success factors on projects. International Journal of Project Management, 20(3):185-190, April 2002.
[26] Khaled El Emam and A. Günes Koru. A replicated survey of it software project failures. IEEE Softw., 25(5):84-90, 2008.
[27] Debra B. Geist and Martha E. Myers. Pedagogy and project management: should you practice what you preach? J. Commit. Small Coll., 23(2):202-208, 2007.
[28] Marko Ikonen and Jaakko Kurhila. Discovering high-impact success factors in capstone software projects. In SIGITE '09: Proceedings of the 10th ACM conference on SIG-information technology education, pages 235-244, New York, N.Y., USA, 2009. ACM.
[29] Zunera Jalil and Arshad Ali Shahid. Is non technical person a better software project manager? In CSSE '08: Proceedings of the 2008 International Conference on Computer Science and Software Engineering, pages 1-5, Washington, D.C., USA, 2008. IEEE Computer Society.
[30] Hairong Lei, Michael Claus, Ron Rammage, C. David Baer, Rene Decool, Joe Michael Kniss, Stephen Clyde, Donald Cooley, and Dongxia Liu. Software's eight essentials. In NISS '09: Proceedings of the 2009 International Conference on New Trends in Information and Service Science, pages 1203-1208, Washington, D.C., USA, 2009. IEEE Computer Society.
[31] Karen Papke-Shields, Catherine Beise, and Jing Quan. Do project managers practice what they preach, and does it matter to project success? International Journal of Project Management, December 2009.
[32] L. Raymond and F. Bergeron. Project management information systems: An empirical study of their impact on project managers and project success. International Journal of Project Management, 26(2):213-220, February 2008.
[33] Brian J. Sauser, Richard R. Reilly, and Aaron J. Shenhar. Why projects fail?how contingency theory can provide new insights—a comparative analysis of nasa's mars climate orbiter loss. International Journal of Project Management, February 2009.
[34] Edgewall Software. The trac project, defect tracking and project management system.
[35] Michael S. V. Turner. Microsoft Solutions Framework Essentials. Microsoft Press, 2006.

1. A method of doing project management by robot:
1. collecting measurable metrics;
2. getting numeric objectives from designated stakeholders;
3. applying project management tools and techniques;
4. assigning, monitoring and closing of project activities;
5. re-iterating.

2. The method and software according to claim 1, wherein the project management is at least one of a project management, an operation management, a working process, a procedure, an operation and other type of activity.

3. The method and software according to claim 1, wherein the robot is at least one of the following: a robot, a software, a hardware, a mechanism and an automata.

4. The method and software according to claim 1, wherein the project management tools and techniques are at least one of the following: a project management tool and technique, a management tool and technique, a tool, a method, an instrument, a principle, an idea and a concept.

5. The method and software according to claim 1, wherein the project activities is at least one of the following: a project activity, an activity, a task, an issue, an order and a work order.
